(19) United States
(12) Patent Application Publication
(10) Pub. No.: US 2010/0280899 A1
(43) Pub. Date: Nov. 4, 2010

(54) FEDERAL AMMUNITION AUTHORITY KIOSK

(75) Inventors: Joseph E. Smith, Minneapolis, MN (US); Mihai Moldoveanu, Coon Rapids, MN (US); Jason M. Nash, St. Francis, MN (US)

Correspondence Address: ATK;c/o Vidas, Arrett & Steinkraus, P.A., 6640 Shady Oak Road, Suite #400, Eden Prairie, MN, 55344-7834, US

(73) Assignee: Alliant Techsystems Inc., Edina, MN (US)

(21) Appl. No.: 11/774,753

(22) Filed: Jul. 9, 2007

(51) Int. Cl. G06Q 30/00; G06F 3/048

(52) U.S. Cl. 705/14.39; 715/809; 715/706

(57) ABSTRACT

An interactive system for assisting a user in the selection of ammunition based upon user entered parameters. A stand-alone kiosk includes a computer having a microprocessor and a memory, an input device in operative communication with the computer for permitting a user to enter parameters, and an output device in operative communication with the computer for providing information from the system to the user. A program is stored in the computer for execution by the microprocessor, the program interactively displaying a series of prompts on the output device, each prompt eliciting a response from the user concerning hunting parameters. The program stores the user inputted parameters in memory, applies predefined rules and/or recommendations against the user inputted parameters to thereby suggest advantageous ammunition, and displays the selected ammunition to the user on the output device.

### CROSS-REFERENCE TO RELATED APPLICATIONS

Not Applicable

### STATEMENT REGARDING FEDERALLY SPONSORED RESEARCH

Not Applicable

### FIELD OF THE INVENTION

This invention is related to an interactive system and method for assisting a user in the selection of ammunition based upon inputted criteria.

### BACKGROUND OF THE INVENTION

Long before climbing into a deer stand or hiding in a duck blind, hunters are faced with a greater challenge: selecting the proper ammunition for the hunt. Because there is no single bullet that works for every hunt, hunters must scrutinize a myriad of different types of ammunition in order to properly prepare for a shoot. With an ever-increasing supply on the market from numerous manufacturers, the selection process to determine which load should be used for a particular pursuit is difficult and time-consuming for even the most avid hunter.

Currently, hunters have three options to guide them in load selection: rely on store catalogs, rely on the sales associate at the point of sale, and/or rely on their own experience. First, store catalogs often just provide highly technical data (e.g. ballastic coefficient and core design), which is of little use to a recreational hunter who may, for example, simply wish to know if a particular 0.22 caliber shell will likely bring down a deer from 200 yards. Second, based on empirical data, sales associates are often not well educated on the differences between the various types of ammunition that they are selling. And finally, consumers are left relying on their own research and experience—oftentimes a frustrating process of trial and error. Therefore, there is a need for educating consumers at the point of sale.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All U.S. patents and applications and all other published documents mentioned anywhere in this application are incorporated herein by reference in their entirety.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided for the purposes of complying with 37 C.F.R. §1.72.

### BRIEF SUMMARY OF THE INVENTION

At least one embodiment of the invention is directed towards an interactive system for assisting a user in the selection of ammunition based upon user entered parameters. The interactive system comprises a computer, an input device, an output device, and a program stored in the computer. The computer comprises a microprocessor and a memory. The input device is in operative communication with the computer for permitting a user to enter parameters. The output device is also in operative communication with the computer for providing information from the system to the user. The program, stored in the computer for execution by the microprocessor, interactively displays a series of prompts on the output device, each prompt eliciting a response from the user concerning hunting parameters. Furthermore, the program stores the user inputted parameters in memory, applies predefined rules and/or recommendations against the user inputted parameters to thereby suggest advantageous ammunition, and displays the selected ammunition to the user on the output device.

Some embodiments of the present invention are directed towards a method of assisting a user in the selection of ammunition based upon user inputted parameters. The method comprises providing a computer having a microprocessor and a memory, providing an input device in operative communication with the computer for permitting a user to enter parameters, providing an output device in operative communication with the computer for providing information from the system to the user, and providing a program stored in the computer and for execution by the microprocessor. The method further comprises prompting the user to input hunting parameters, storing the parameters in a memory, applying predefined rules and/or recommendations against the parameters, selecting advantageous ammunition from a database, and displaying the selected ammunition to the user on the output device.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE DRAWINGS

A detailed description of the invention is hereafter described with specific reference being made to the drawings.

FIG. 1 is a perspective view of an embodiment of the present invention depicting an interactive kiosk including ammunition.

FIG. 2 is a diagram of an embodiment of the present invention depicting the electrical and electronic components inside the kiosk enclosure.

FIG. 3 is a block diagram of an embodiment of the present invention depicting the kiosk software stack.

FIG. 4 is a diagram of an embodiment of the present invention depicting tables in a database.

FIG. 5 is a flowchart of an embodiment of the present invention depicting the flow from a kiosk screensaver to a recommended load based upon user inputted parameters of caliber, game, and range.

FIG. 6 is a flowchart of an embodiment of the present invention depicting a method of assisting a user in the selection of ammunition based upon user inputted parameters.

### DETAILED DESCRIPTION OF THE INVENTION

While this invention may be embodied in many forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

The present invention, an interactive kiosk, is directed towards a database-driven product selector that provides expert load recommendations based on user-inputted criteria. The criteria includes the type of game, the desired caliber, and the range of shot. Furthermore, the kiosk includes a dynamic interface with a host that not only guides the user through the selection process, but also provides additional information for each of the products available. Although the kiosk can be installed at a number of locations, a primary location is at retail stores that sell ammunition.

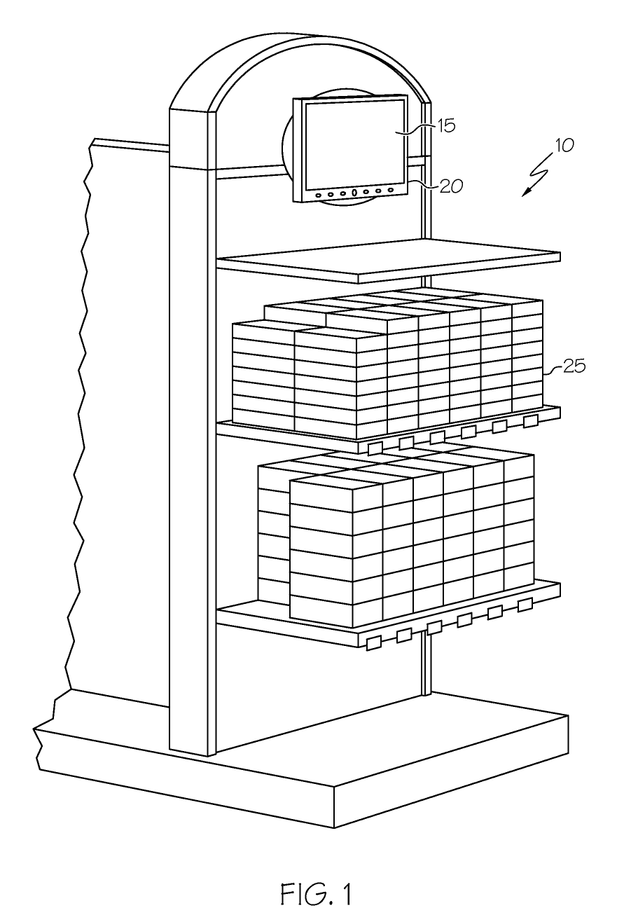

In the embodiment depicted in FIG. 1, an interactive kiosk 10 is shown with touchscreen 15, kiosk cabinet 20, and product 25.

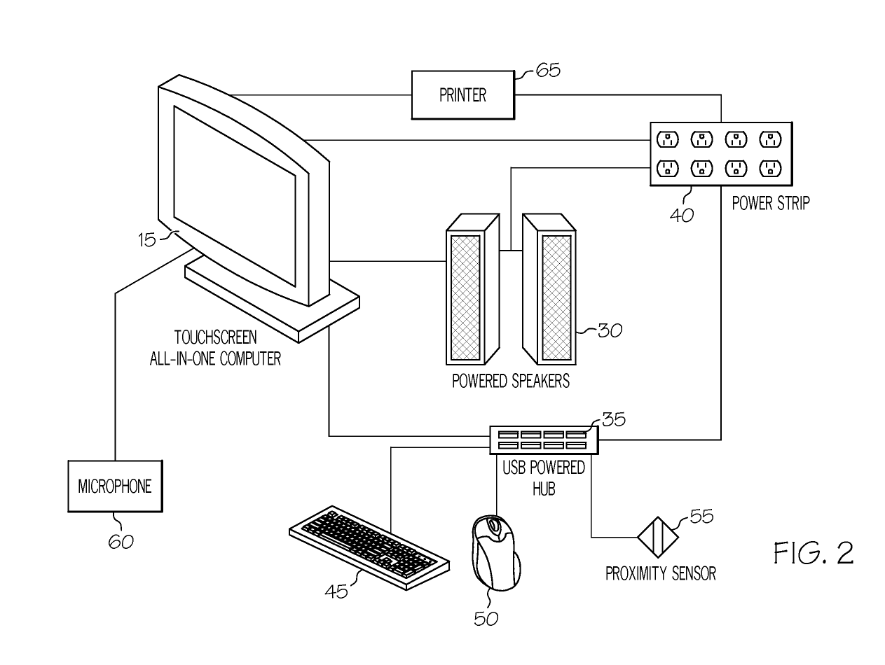

FIG. 2 depicts the electrical/electronic components that comprise an embodiment of the interactive kiosk 10, namely an all-in-one computer 15 connected to powered speakers 30, and a USB powered hub 35, all of which are connected to a supply voltage, such as through power strip 40. In at least one embodiment, the computer 15 includes a touchscreen. An example of a computer with touchscreen is the R-Tech-15 R-755 Touch Terminal, available from Instruments and Equipment Company, Kiosk Division, Sparta, N.J.

While it is envisioned that a user will use the computer 15 with touchscreen as the primary input device when requested to input parameters, the interactive kiosk 10 further includes a keyboard 45 and a mouse 50 that can be used for initial kiosk setup as well as a contingency in case of touchscreen equipment failure. FIG. 2 also depicts an optional proximity sensor 55 that can be connected to the interactive kiosk 10. When a customer is within a predetermined range of the proximity sensor, the sensor can be set to begin executing the program and initiate voice interaction, thereby drawing the customer's attention to the kiosk.

One of ordinary skill will recognize that there are a number of alternative components that may be substituted for, or added to, the components in the above list in order to produce alternative embodiments of the interactive kiosk without deviating from the spirit of the invention. For example, in some embodiments, rather than using a touchscreen as the primary input device, a monitor such as a cathode ray tube (CRT) or liquid crystal display (LCD) could be used as a display, and the keyboard and/or mouse would be used as the primary input device. In at least one embodiment, the computer may include speech recognition software that can be used in conjunction with a microphone 60 as an input device. In some embodiments, a printer 65 may be attached as an output device in addition to, or as a substitute for, the speakers 30.

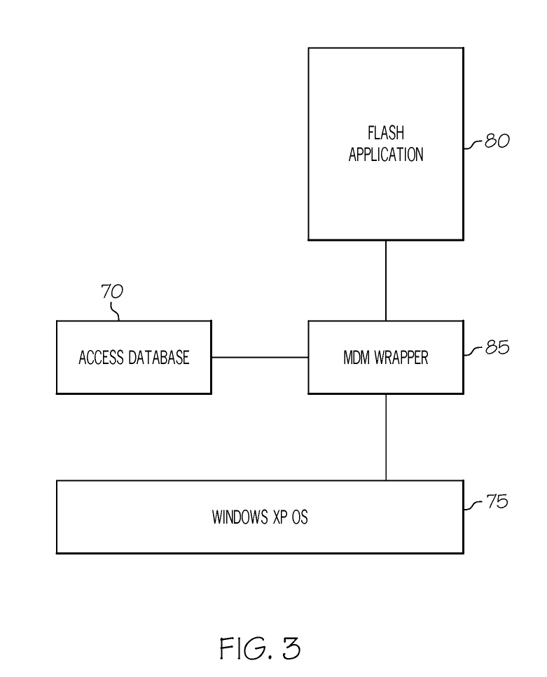

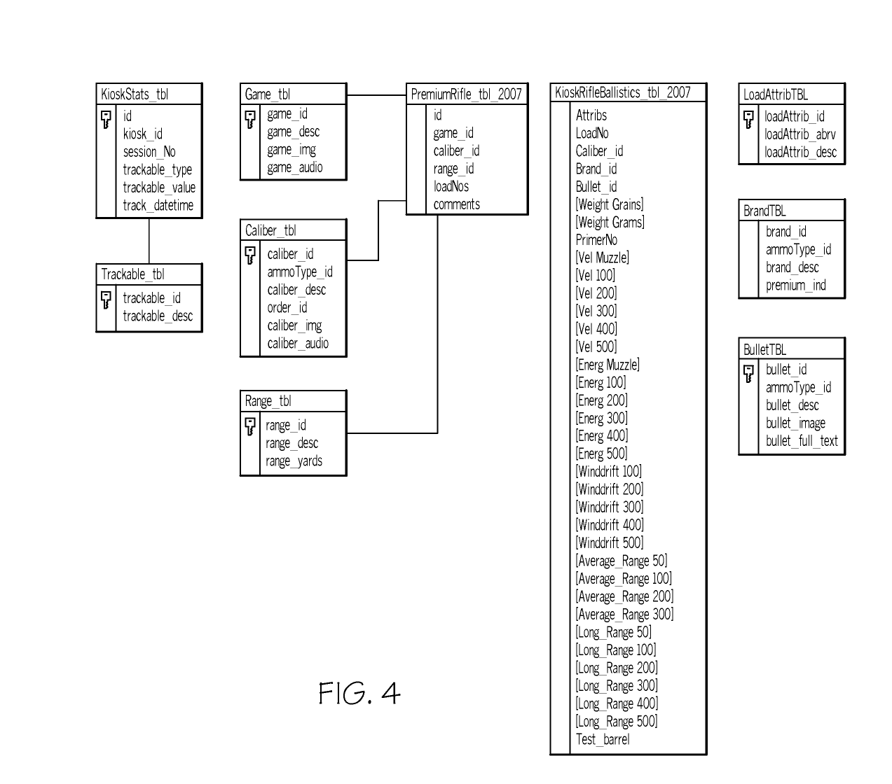

Referring now to FIG. 3, a block diagram of at least one embodiment of a kiosk software stack is illustrated. As shown in FIG. 3, Windows XP is the operating system (OS) on which the kiosk software has been designed to run. FIG. 3 further depicts an Access Database 70 running on the OS 75. Expert load recommendations, types of game, caliber information, ranges, and load ballistics are stored in the Access Database. Specifically, each of these sets of data is stored in tables within the database 70, as shown in FIG. 4. Referring again to FIG. 3, the software running the animation, video, and interactivity on the kiosk is developed using Adobe® Flash 80 (“Flash”). To expand the functionality of the Flash application 80, particularly database and OS communication, the Flash application 80 is wrapped in MDM Wrapper 85 created using MDM Studio™. One of ordinary skill will recognize that there are a number of alternative embodiments to the software stack that can used to produce an interactive kiosk without deviating from the spirit of the invention. For example, the OS could be Mac OS X, Unix, Linux, Windows Vista, or any other commercially available operating system. Or, rather than using Flash, the application could be built using another integrated development environment (IDE) or programming language such as Java or C#. Alternatively, another wrapper and/or database could be used. Examples of alternative databases include but are not limited to MS-SQL and mySQL.

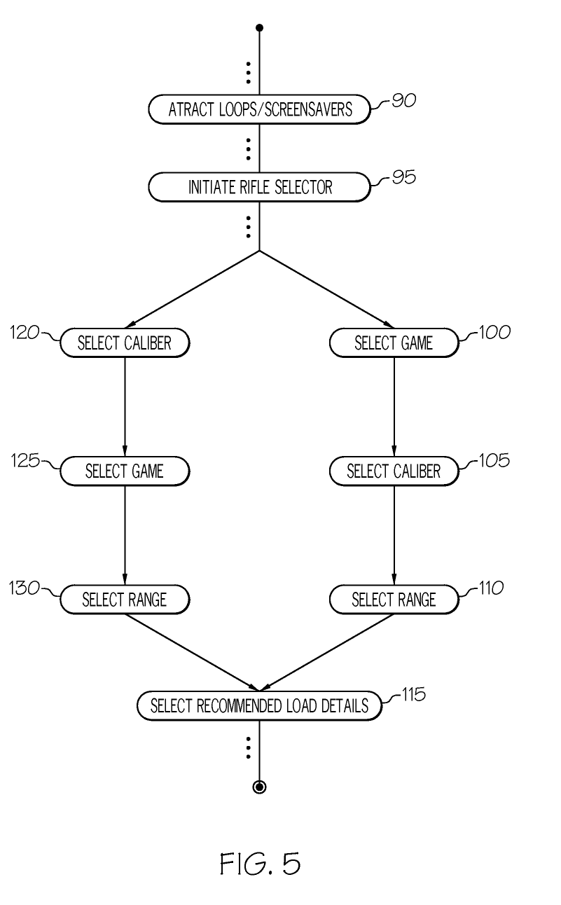

Now, referring to FIG. 5, a flowchart is presented detailing the kiosk activity. When the kiosk is idle for a predetermined amount of time, a screensaver 90 is initiated to prevent burn-in on the display. The screensaver projects logos, single images, multiple images, including commercials, as well as education and tips. If using a touchscreen, in at least one embodiment, the initiate rifle selector 95 step is performed by simply touching the screen. The user is then prompted by the program, and in some embodiments by the live host of the dynamic interface, to input the game 100 to be hunted, the caliber 105 required, and the range 110 of the shot. After steps 100-110 are performed, a load is recommended 115 which can be selected in order for the user to further assess its capability. As seen in FIG. 5, steps 120-130 provide an alternate path to the recommended load 115 in that the user can select the caliber 120 and then the game 125. It should be noted that in other embodiments, the range is the first criteria to be input.

As mentioned above, the software provides a dynamic interface, or “live host”, to guide a user through the program. In some embodiments, the live host provides education on topics such as rifle shooting basics, sighting a rifle, bullet trajectory, and a bullet guide. This educational information is useful for both consumers as well as for the sales personnel at the retail store; sales personnel can watch the educational information when there is downtime in the store. In at least one embodiment, the live host is a video of a human. In some embodiments, the live host is an animated human. In at least one embodiment, the live host is an animation. In some embodiments, the live host is a recorded voice. In at least one embodiment, the live host is simply text on the screen in the form of dialog boxes.

After the program has been initiated, the program interactively displays a series of prompts with the live host explaining the requested information and prompting the user to input hunting parameters or other information. The user touches the touchscreen to enter the requested information, or, alternatively, uses another input device such as a keyboard or mouse. This information is stored in the computer's memory. After the user has input either some or all the requested information, the program applies predefined rules and/or recommendations against the user parameters in order to recommend a load. The recommended ammunition is then communicated to the user via an output device such as the display, a printer, through speakers, or a combination thereof. The recommended ammunition may be a single type of load, or there may be multiple types recommended.

Although the present invention is directed towards rifles, it should be noted that the kiosk could also be used to help consumers purchase shotshell, rimfire, and bullets for pistols. One of ordinary skill would recognize that modifications to the database, specifically the tables, would be required, as well as the flash application, in order to accommodate such changes.

It should also be noted that although the game, the caliber, and the range are the primary input parameters, the program could be modified to incorporate additional or substitute parameters. For instance, the input criteria may include the firearm type. Or, a user may only be interested in purchasing loads without lead (i.e. non-toxic loads).

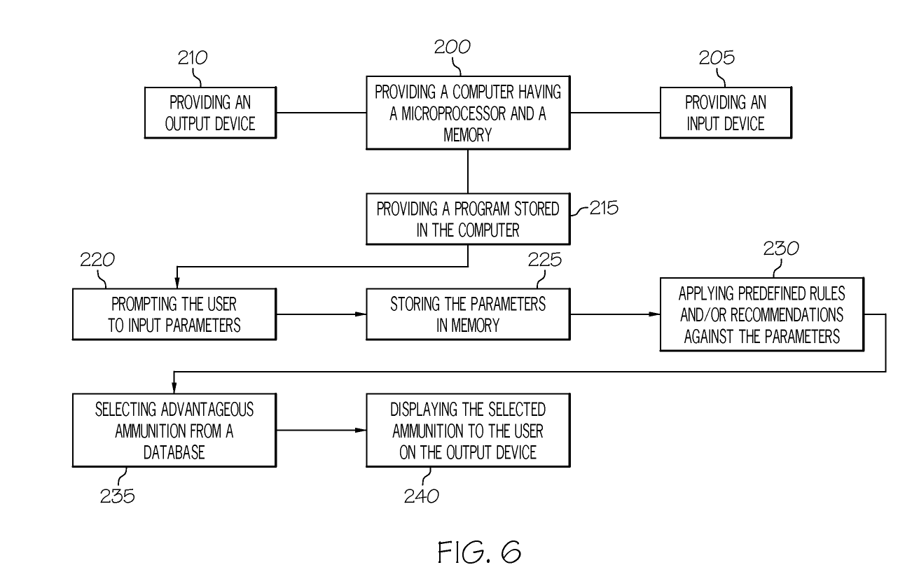

In at least one embodiment, the present invention is directed towards a method of assisting a user in the selection of ammunition based upon user inputted parameters. In some embodiments the method comprises providing a computer 15 having a microprocessor and a memory, indicated at 200 in FIG. 6. The computer may be an all-in-one computer or may be a computer with a separate display device, depending on the space constraints of the kiosk cabinet. The method further comprises providing an input device in operative communication with the computer for permitting a user to enter parameters, indicated at 205 in FIG. 6. The input device may be a touchscreen, a keyboard, a mouse, or a microphone used in conjunction with speech recognition software. At block 210, an output device in operative communication with the computer is provided for communicating information from the system to the user. The output device may be a touchscreen, a CRT or LCD monitor, a printer, or powered speakers. The method further comprises providing a program stored in the computer and for execution by the microprocessor, indicated at block 215. At block 220, the user is prompted to input parameters. In some embodiments, the parameters comprise the type of game to be hunted, the range of the shot, the caliber of load required, or a combination of these parameters. These parameters are stored in the memory of the computer, as indicated at block 225. At block 230, the program applies predefined rules and/or recommendations against the parameters stored in memory. The method further comprises selecting advantageous ammunition from a database, shown at block 235. Block 235 shows that the system displays the selected ammunition to the user on the output device.

In some embodiments of the invention, the method further includes providing the computer with a database which contains the load recommendations and rules, as well as the load types, caliber information, and ballistic information. It should be noted that there are a number of other load attributes that one of ordinary skill would recognize would be desirable to store.

In at least one embodiment of the present invention, the computer is connected to a server via an Internet connection, the database being stored on the server. In this manner, the database tables, or other database files, could be updated at a central location that is remotely accessible. Such a centralized database prevents multiple versions from existing on remote terminals, and simplifies updating the database as new products are introduced or as new recommendations become available.

Even if the database and the program reside on the computer in the kiosk, the Internet connection is used to transfer updated database files or program files, thereby eliminating the need to send a technician or engineer to the site of the kiosk. The kiosks are networked together for better maintenance and data relay. In some embodiments, a module is created that will push/pull data at regular intervals to synchronize with a central server. In at least one embodiment, cellular modems are installed, allowing dial-in access to a connected kiosk.

In some embodiments, the method includes a program with a live host, the live host providing guidance to the user. The live host may be an animated human, a recorded human, an animation, a recorded voice, or simply text in the form of dialog boxes, or a combination of the above.

In at least one embodiment, the method further comprising a user-specific rebate based upon the suggested ammunition. That is, after the program recommends a load to the user, as an incentive to purchase the recommended load, the program will generate a rebate to provide an incentive for the user to purchase that load.

In some embodiments, the method further comprises displaying a user-specific promotion based upon the suggested ammunition and/or the user inputted parameters. For example, after the program recommends a load to the user, as an incentive to purchase the recommended load, the program will show a promotion that the user will receive a discount if multiple boxes of the recommended ammunition are purchased.

In at least one embodiment, the method further comprises displaying advertisements and/or commercials. The program can run, either as a screensaver or in addition to a screensaver, commercials, advertisements, or seasonal advertisements related to products available for purchase or upcoming products. For example, while the user may be purchasing a load to hunt deer, an advertisement for a load used to hunt pheasant may entice the user to make an additional purchase.

In some embodiments, the method further comprises providing a digital catalog of available products.

In at least one embodiment, the method further comprises displaying educational information. Education topics such as rifle shooting basics, sighting a rifle, bullet trajectory, and a bullet guide are provided to the user.

In some embodiments, the method includes collecting user data such as what recommended load was displayed most frequently, what was the most used combination of input parameters, and after which section of the program did the screensaver activate. This data is useful on a regional level and is used to assist sales departments fulfill the needs of their target region.

In at least one embodiment, the method includes providing the kiosk with a reporting module that is integrated with a customer relationship management solution in order to provide real-time data from stores where the kiosk is located.

In some embodiments, the method includes linking the kiosk and the inventory management system of the retail store where the kiosk is located in order to provide real-time information to the user about the recommended loads. For example, after the program selects a load based on the user inputted criteria, the program sends the load information (e.g. stocking keeping unit number or “SKU”) to the inventory management system to determine if the load is in stock. If the load is in stock, the program proceeds with the recommendation. If the load is not in stock, the program outputs the recommendation to the user but suggests an alternative load, if there is one, that is in stock.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. An interactive system for assisting a user in the selection of ammunition based upon user entered parameters, comprising:
a computer having a microprocessor and a memory;
an input device in operative communication with the computer for permitting a user to enter parameters;
an output device in operative communication with the computer for providing information from the system to the user; and
a program stored in the computer and for execution by the microprocessor, the program interactively displaying a series of prompts on the output device, each prompt eliciting a response from the user concerning hunting parameters,
wherein the program stores the user inputted parameters in memory, and
wherein the program applies predefined rules and/or recommendations against the user inputted parameters to thereby suggest advantageous ammunition, and
wherein the program displays the suggested ammunition to the user on the output device.

2. The system of claim 1, wherein the program is in operative communication with a database.

3. The system of claim 2, wherein at least a portion of the database is updatable.

4. The system of claim 1, wherein the program comprises a live host, the live host providing guidance to the user.

5. The system of claim 4, wherein the live host is selected from the group consisting of an animated human, a recorded human, an animation, and a recorded voice.

6. The system of claim 1, wherein the inputted parameters are selected from the group consisting of the type of game to be hunted, the range of shot, and the caliber required.

7. The system of claim 1, wherein the program is updated via an Internet connection to a server.

8. The system of claim 1, wherein the input device is a touchscreen monitor.

9. The system of claim 1, wherein the input device is a mouse.

10. The system of claim 1, wherein the input device is a keyboard.

11. The system of claim 1, wherein the input is speech recognition software.

12. The system of claim 1, wherein the output device comprises a monitor.

13. The system of claim 12, wherein the monitor is a touchscreen monitor.

14. The system of claim 1, wherein the output device comprises a printer.

15. The system of claim 1, wherein the output device comprises a speaker.

16. The system of claim 1, the system being located in a retail store.

17. The system of claim 1, wherein the computer is in operative communication with the store's inventory tracking system such that suggested ammunition will be checked against the store's inventory.

18. A method of assisting a user in the selection of ammunition based upon user inputted parameters, comprising:
providing a computer having a microprocessor and a memory;
providing an input device in operative communication with the computer for permitting a user to enter parameters;
providing an output device in operative communication with the computer for providing information from the system to the user;
providing a program stored in the computer and for execution by the microprocessor;
prompting the user to input hunting parameters;
storing the parameters in a memory;
applying predefined rules and/or recommendations against the parameters;
selecting advantageous ammunition from a database; and
displaying the selected ammunition to the user on the output device.

19. The method of claim 18, wherein the computer comprises a database.

20. The method of claim 18, wherein the computer is connected to a server via an Internet connection, the database being stored on the server.

21. The method of claim 18, wherein the hunting parameters comprise the type of game to be hunted, the range of shot, and the caliber required.

22. The method of claim 21, wherein the program further comprises a live host, the live host providing guidance to the user.

23. The method of claim 22, wherein the live host is selected from the group consisting of an animated human, a recorded human, an animation, and a recorded voice.

24. The method of claim 18, further comprising creating a user-specific rebate based upon the suggested ammunition.

25. The method of claim 18, further comprising displaying a user-specific promotion based upon the suggested ammunition and/or the user inputted parameters.

26. The method of claim 18, further comprising displaying advertisements and/or commercials.

27. The method of claim 18, further comprising providing a digital catalog of available products.

28. The method of claim 18, further comprising displaying educational information.
